(19) United States
(12) Patent Application Publication
(10) Pub. No.: US 2015/0189859 A1
(43) Pub. Date: Jul. 9, 2015

(54) Animal Waste Collecting Device

(71) Applicant: George John, Mississauga (CA)

(72) Inventor: George John, Mississauga (CA)

(21) Appl. No.: 14/465,011

(22) Filed: Aug. 21, 2014

Related U.S. Application Data
(60) Provisional application No. 61/868,384, filed on Aug. 21, 2013.

(51) Int. Cl. A01K 23/00; A01K 27/00

(52) U.S. Cl. CPC A01K 23/00; A01K 27/002

(57) ABSTRACT

Disclosed is an animal waste collecting device. The device includes a harness that includes an adjustable waist strap that is attached to a back strap and a pair of leg straps. The leg straps are connected by means of a connecting rod of a receptacle holder, wherein the receptacle holder is positioned adjacent to an animal's buttocks. The connecting rod includes a rotatable rod attached thereto, wherein the rotatable rod includes a pair of bag attachment rods for holding a disposable bag thereon. The connecting rod is connected to the pull straps so that when the pull straps are actuated, the connecting rod moves the rotatable rod and the bag attachment rods. In this way, the disposable bag can be automatically positioned to collect animal waste as the animal defecates, thereby eliminating the need for an animal owner to pick up animal waste by hand.

### CROSS REFERENCE TO RELATED APPLICATION

This application claims the benefit of U.S. Provisional Application No. 61/868,384 filed on Aug. 21, 2013. The above identified patent application is herein incorporated by reference in its entirety to provide continuity of disclosure.

### BACKGROUND OF THE INVENTION

1. Field of the Invention

The present invention relates to a harness-like device for collecting animal waste. More specifically, the present invention pertains to an improved harness device for collecting animal feces, and in a preferred embodiment, the harness is designed to be worn by a dog.

Many places require dog owners to clean up or pick up after their dog. In addition to being unsightly and odorous, dog waste is a breeding medium for germs and disease and can spread disease to people and other dogs. Bacteria can make its way into streams and lakes, and play a significant role in water pollution, especially in cities. Picking up dog waste, however, can be an unpleasant task. This is particularly true when dog owners are walking multiple dogs or walking dogs in inclement weather.

Some dog owners utilize plastic bags to pick up dog waste from the ground. However, plastic bags can rip easily and the dog owners may get dog waste on their hands. Additionally, the dog owner must carry the bag after picking up the dog waste. Other dog owners utilize a scoop or a shovel to pick up dog waste. These devices generally comprise a handle with a scoop or a shovel on one end. While these devices allow the dog owners to pick up dog waste without using their hands, these devices are bulky and inconvenient to carry when walking a dog. Thus, a device that enables a dog owner to collect dog waste in a hands-free manner is desired.

The present invention provides an animal waste collection device comprising a harness. In the exemplary embodiment, the harness is designed to hold a disposable bag on the backside of a dog in an area below the dog's tail. The harness comprises a waist strap that is adapted to wrap around the dog's waist or loin. The waist strap functions similarly to a belt and is adjustable in length. The waist strap further includes a back strap and a pair of leg straps. The back strap spans along the dog's back so that it connects the waist strap to a dog collar. Each of the leg straps form a closed loop that is adapted to receive the dog's hind legs therethrough. Disposed between the leg straps is a receptacle holder for collecting the dog's waste. The receptacle holder comprises a connecting rod, which slideably connects the leg straps together, and comprises a rotating rod attached thereto. The rotating rod comprises a pair of bag attachment rods for holding a disposable bag thereon. The connecting rod is connected to a pair of pull straps that is secured to the dog's hind legs by means of a pair of ankle bands. The dog can pull the pull straps by moving into a squatting position, whereby pulling the pull straps pivots the rotating rod and automatically positions the disposable bag to collect dog waste. Thereafter, the disposable bag can be released from the bag attachment rods when the dog moves back into a standing position.

In this way, the present invention allows dog owners to collect dog waste in a hands-free manner, thereby providing convenience to the dog owners while encouraging them to properly dispose of dog waste. Additionally, the present invention is suitable for indoor as well as outdoor use. The present animal waste collection device allows dogs to eliminate waste naturally without constant supervision, and further allows the waste material to be immediately collected without coming into contact with the dog's body or the ground.

2. Description of the Prior Art

Devices have been disclosed in the prior art that claim excrement catching device for use with dogs. These include devices that have been patented and published in patent application publications. Some of these devices can be worn by a dog, and generally include a harness and a receptacle holder. Other devices disclose a handheld device that is used to pick up and collect feces. These devices, however, do not disclose a waste collecting device having a harness with a pivotally mounted receptacle holder.

The devices disclosed in the prior art have several known drawbacks. Some of these devices are designed to be secured around a dog's tail and are uncomfortable for dogs to wear while walking. Other devices are bulky and inconvenient for the dog owners to carry when walking their dog. The present invention overcomes these limitations by disclosing a harness that allows dogs to move freely while walking. The harness can be secured to the dog collar or another similar device and around the dog's waist or loin so that it is secured close to the dog's body without interfering with the dog's movement. Additionally, the present invention comprises a removably attached disposable bag so as to enable the dog owner to collect dog waste in a hands-free manner.

It is therefore submitted that the present invention is substantially divergent in design elements from the prior art, and consequently it is clear that there is a need in the art for an improvement to animal waste collecting device for use with dogs. In this regard, the instant invention substantially fulfills these needs.

### SUMMARY OF THE INVENTION

In view of the foregoing disadvantages inherent in the known types of excrement catching device for use with dogs now present in the prior art, the present invention provides a new and improved animal waste collecting device wherein the same can be utilized for collecting dog waste in a hands-free manner.

It is therefore an object of the invention to provide a new and improved animal waste collecting device that has all of the advantages of the prior art and none of the disadvantages.

Another object of the present invention is to provide a new and improved animal waste collecting device having an adjustable harness with a pivotally attached receptacle holder wherein the receptacle holder can be moved into a horizontal position by means of a pair of pull straps when the dog is in a squat position.

Yet another object of the present invention is to provide a new and improved animal waste collecting device that can be worn around a dog's waist and hindquarters.

Yet another object of the present invention is to provide a new and improved animal waste collecting device having a removably attached disposable bag.

Yet another object of the present invention is to provide a new and improved animal waste collecting device that allows dog owners to collect dog waste in a hands-free manner.

Yet another object of the present invention is to provide a new and improved animal waste collecting device that does not impede a dog's natural movement and is comfortable to wear.

Still yet another object of the present invention is to provide a new and improved animal waste collecting device wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of the present invention.

FIG. 2 shows a view of the present invention as worn by a dog.

FIG. 3 shows a view of the invention as used to catch dog waste while worn by a dog.

FIG. 4 shows a view of the removable disposable bag feature of the present invention.

### DETAILED DESCRIPTION OF THE INVENTION

References are made herein to the attached drawings. Like reference numerals are used throughout the drawings to depict like or similar elements of the animal waste collecting device. For the purposes of presenting a brief and clear description of the present invention, the preferred embodiment will be discussed as used to collect dog waste in a hands-free manner. The figures are intended for representative purposes only and should not be considered to be limiting in any respect.

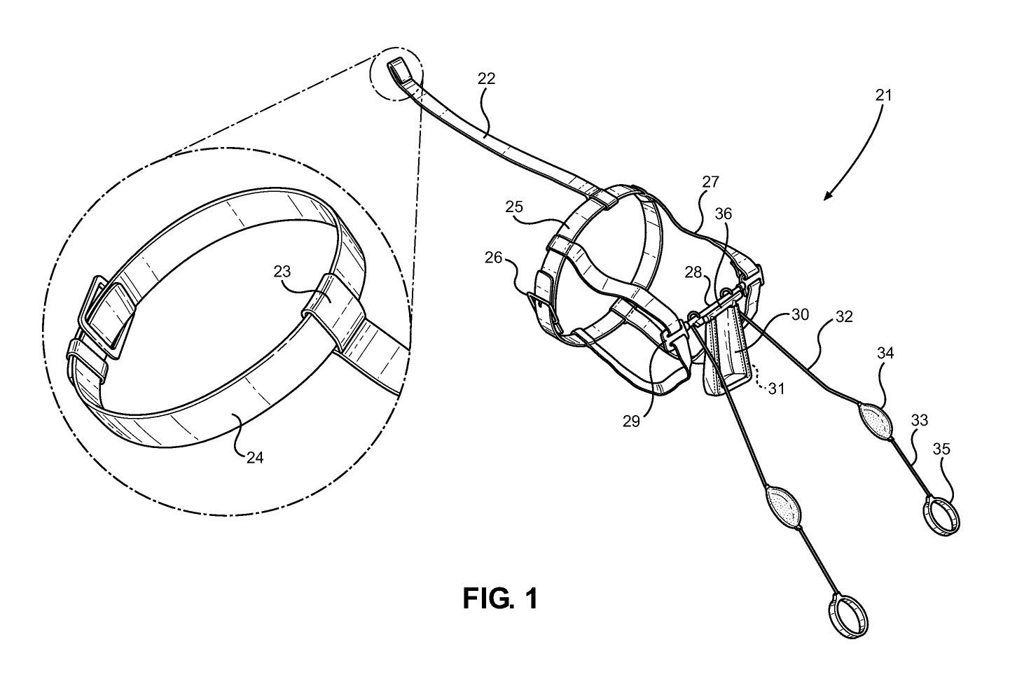

Referring now to FIG. 1, there is shown a perspective view of the present invention. The animal waste collecting device of the present invention comprises a harness 21 having an adjustable waist strap 25 attached to an elongated back strap 22 and a pair of leg straps 27. The harness 21 is composed of durable material such as nylon or other suitable material. The waist strap 25 comprises a buckle 26 thereon so that the waist strap 25 functions similar to a belt and is adjustable in length. The back strap 22 comprises a first end and a second end. The first end of the back strap 22 comprises a closed loop 23 that is adapted to receive a dog collar 24 therethrough. The second end of the back strap 22 is attached to the waist strap 25.

Each of the ends of the leg straps 27 are connected to the waist strap 25 so as to form closed loops. In this way, when viewed from the side, each of the leg straps 27 substantially form a U-shape. The leg straps 27 are connected together by means of a receptacle holder having a connecting rod 28 disposed opposite of the waist strap 25. The connecting rod 28 comprises an interior rod having a first end and a second end, and an exterior rod having a hollow cylindrical structure. The diameter of the cross section of the exterior rod is greater than the diameter of the cross section of the interior rod so that the exterior rod can freely rotate about the interior rod. Each of the first end and the second end of the interior rod comprises a buckle 29 thereon. Each of the buckles 29 is slideably connected to one leg strap 27 so that the connecting rod 28 can move along the length thereof.

The receptacle holder further comprises a rotating rod 36 having a pair of bag attachment rods 31 affixed thereto. The rotating rod 36 is attached to the exterior rod of the connecting rod 28 so that the rotating rod 36 can rotate with respect to the interior rod of the connecting rod 28. The rotating rod 36 comprises a pair of bag attachment rods 31 perpendicularly attached thereto. The bag attachment rods 31 are separated by a space and can be positioned so that their ends are pointing in a downward direction or are substantially level with horizontal. The bag attachment rods 31 are adapted to removably secure a disposable bag. The disposable bag 30 has an opening with a defined interior volume. The periphery of the opening of the disposable bag 30 is adapted to receive the bag attachment rods 31 therein. The bag attachment rods 31 are inserted into the periphery of the opening so that the bag 30 is secured in an open configuration when in use.

The exterior rod of the connecting rod 28 and the rotating rod 36 can rotate concurrently by means of a pair of pull straps connected to the exterior rod of the connecting rod 28. The pull straps comprise an upper strap 32, a lower strap 33, and a hock joint pad 34 therebetween. Each of the upper strap 32 and the lower strap 33 may be composed of cords, ropes, or the like. The upper 32 and lower straps 33 each comprise a first and a second end. The first end of the upper strap 32 is connected to the rotating rod 36 and the second end of the upper strap 32 is connected to the hock joint pad 34. The first end of the lower strap 33 is connected to the hock joint pad 34 and the second end of the lower strap 33 is connected to an ankle band 35. The hock joint pad 34 is substantially oval in shape and is configured to fit the contours of a hock joint of a dog. In some embodiments, the hock joint pad 34 may be composed of plastic or other suitable material, and comprise cushioning or padding thereon. When the pull straps are pulled, the rotating rod pivots so that the bag attachment rods 31 are moved into a substantially horizontal position from a substantially vertical position, thereby moving the disposable bag 30 on the receptacle holder to a substantially horizontal position therewith.

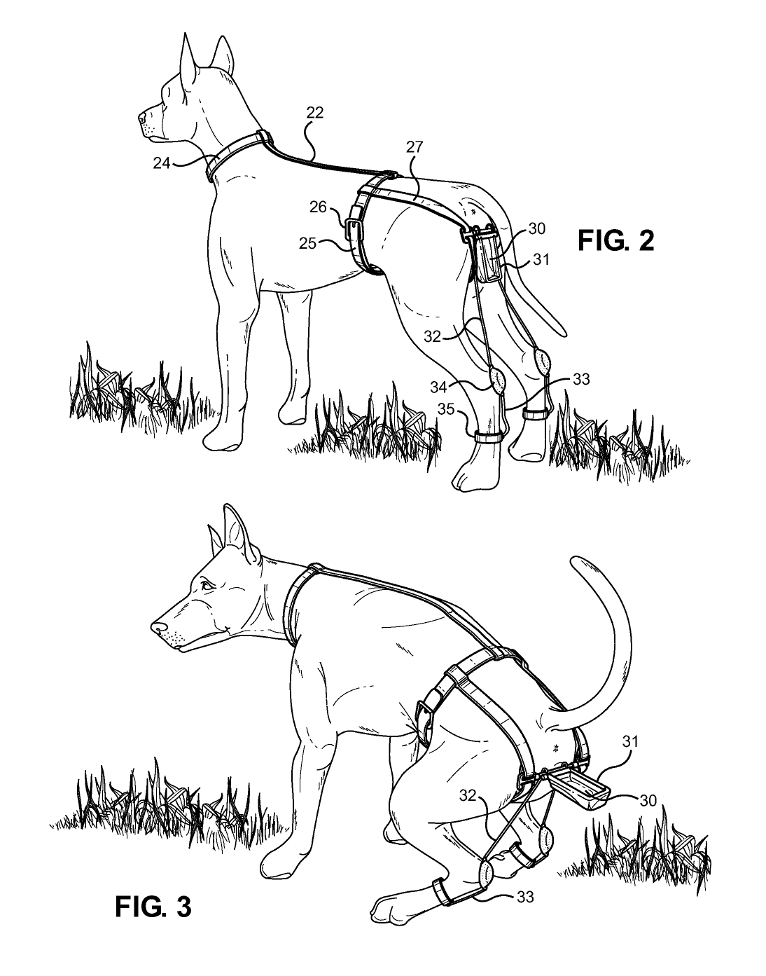

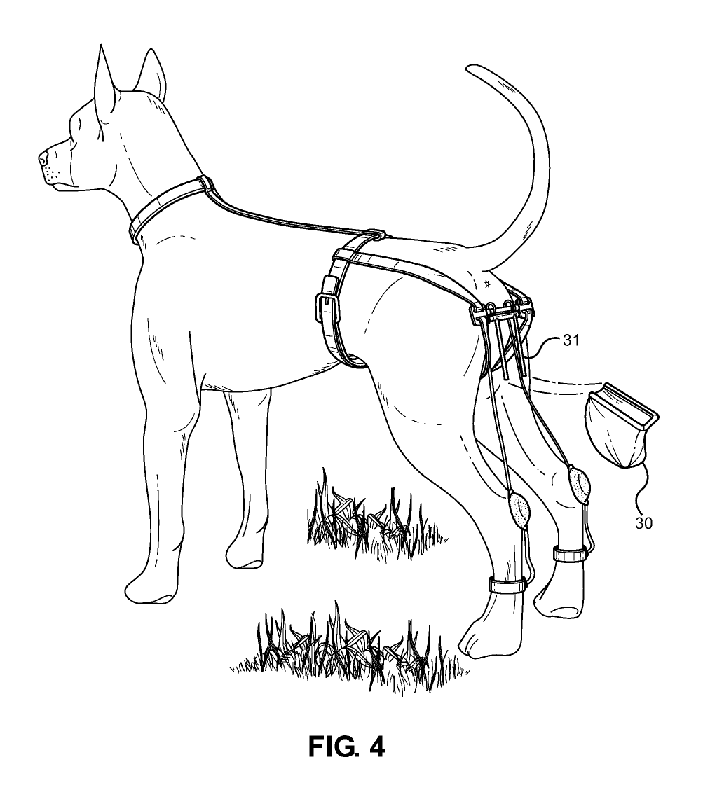

Referring now to FIGS. 2 and 3 in conjunction with FIG. 4, there are shown views of the present invention in use. In the illustrated embodiment, the harness is worn by a dog so that the waist strap 25 is wrapped around the dog's waist or loin and the back strap 22 spans along the length of the dog's back to connect to a dog collar 24 worn around the dog's neck. The waist strap 25 may be adjusted in length by means of the buckle 26 disposed thereon. In this way, the harness may be worn by dogs of various sizes.

Each of the dog's hind legs are looped through the leg straps 27 so that the receptacle holder is positioned underneath the dog's tail and adjacent to the dog's buttocks. The rotating rod of the receptacle holder is attached to the pair of pull straps extending downward therefrom. The pull straps are worn such that the ankle bands 35 wrap around the dog's ankles and the hock joint pads 34 directly contact the dog's hock joints at the back of the dog's legs. In this way, the upper straps 32 extend between the dog's buttocks and the dog's hock joints, and the lower straps 33 extend between the dog's hock joints and the dog's ankles.

When the dog is in a standing position as shown in FIG. 2, the receptacle holder is in a substantially vertical position so that the free ends of the bag attachment rods 31 are pointing in a downward direction and the opening of the disposable bag 30 is facing outward and away from the dog. Additionally, the pull straps are not taut or held tightly in position when the dog is standing, thereby allowing the dog to walk and move freely. When the dog is in a squatting position as shown in FIG. 3, each of the upper 32 and lower 33 straps are taut and the receptacle holder is pulled into a substantially horizontal position. In this way, the disposable bag 30 is in position to immediately collect dog waste as the dog defecates. This eliminates the need for the dog owner to pick up dog waste from the ground.

The receptacle holder moves back into a substantially vertical position and the disposable bag 30 can detach from the attachment rods 31 when the dog stands back upright from the squatting position. The contaminated disposable bag 30 may then be easily discarded, and a replacement disposable bag 30 may be placed on the attachment rods 31. When the disposable bag 30 is placed on the attachment rods 31, it is contemplated that the bag 30 may stretch slightly so that it is tightly and snugly fitted onto the rods 31 and prevented from falling therefrom without use of fasteners or the like.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An animal waste collecting device, comprising:
a harness having an adjustable waist strap that is connected to a back strap and a pair of leg straps;
a receptacle holder having a connecting rod;
said connecting rod connecting said pair of leg straps together;
wherein said receptacle holder is adapted to be positioned underneath an animal's tail and adjacent to an animal's buttock;
a pair of pull straps connected to said connecting rod and an animal's ankles;
wherein pulling said pair of pull straps moves said receptacle holder from a substantially vertical position to a substantially horizontal position to collect animal waste in a disposable bag.

2) The animal waste collecting device of claim 1, wherein said receptacle holder further comprises:
a rotating rod affixed to said connecting rod;
a pair of bag attachment rods for holding said disposable bag thereon;
said pair of bag attachment rods affixed to said rotating rod.

3) The animal waste collecting device of claim 2, wherein said rotating rod and said connecting rod can rotate concurrently.

4) The animal waste collection device of claim 2, wherein said pair of bag attachment rods are perpendicularly affixed to said rotating rod.

5) The animal waste collecting device of claim 2, wherein each of said pair of bag attachment rods comprise a free end to engage an opening of said disposable bag.

6) The animal waste collection device of claim 1, wherein said pair of pull straps comprises an upper strap, a lower strap, a hock joint pad, and an ankle band;
said upper strap connected to said connecting rod and said hock joint pad;
said lower strap connected to said hock joint pad and said ankle band.

7) The animal waste collecting device of claim 1, wherein said waist strap comprises a buckle adapted to allow the length of the waist strap to be adjusted.

8) The animal waste collecting device of claim 1, wherein said connecting rod comprises an interior rod and an exterior rod;
said interior rod having a first end and a second end;
each of said first end and said second end of said connecting rod comprising a buckle that is slideably connected to said pair of leg straps;
said exterior rod connected to a rotating rod and said pair of pull straps.

9) The animal waste collecting device of claim 1, wherein each of said pair of leg straps comprise a first end and a second end;
each of said first end and said second end of said pair of leg straps connected to said waist strap, forming a U-shaped closed loop to receive a hind leg of an animal therethrough.

10) The animal waste collecting device of claim 1, wherein said back strap comprises a first end and a second end;
said first end of said back strap comprising a closed loop that is adapted to receive an animal collar therethrough.
